(19) United States
(12) Patent Application Publication
(10) Pub. No.: US 2009/0217281 A1
(43) Pub. Date: Aug. 27, 2009

(54) Adaptable Redundant Bit Steering for DRAM Memory Failures

(76) Inventor: John M Borkenhagen, Rochester, MN (US)

Correspondence Address: IBM CORPORATION, 3605 HIGHWAY 52 NORTH, DEPT. 917, BUILDING 006-1, ROCHESTER, MN, 55901-7829, US

(21) Appl. No.: 12/035,735

(22) Filed: Feb. 22, 2008

(51) Int. Cl. G06F 9/46

(52) U.S. Cl. 718/104

(57) ABSTRACT

A method, computer program product and computer system for assigning computing resources in a computer system to solve multiple problems where tolerances to the problems are countable and have pre-set thresholds, and solutions to the problems share resources exclusively. The method, computer program product and system include counting the tolerances using at least one counter, assigning resources to solve a problem if the tolerance to the problem is higher than a first pre-set threshold, and reassigning resources to solve a second problem if the tolerance to the second problem is higher than a second pre-set threshold. The method, computer program product and system can also adopt an alternative solution that does not share resources exclusively with a current solution to solve the problems.

### BACKGROUND

1. Technical Field

The present invention relates to the optimization of DRAM failure toleration. More specifically, it relates to a method and a system for enabling adaptable redundant bit steering when DRAM memory fails.

2. Background Information

Memory interfaces use an Error Correction Code (ECC) to tolerate Dynamic Random Access Memory (DRAM) bit failures. ECCs use extra non-data DRAM bits on the memory interface to detect failing DRAM bits, and to recreate good data using data read from multiple DRAMs, including the failing one, along with the ECC bits. Many memory controllers employ an ECC scheme that uses a part of the non-data bits on the memory interface for ECC and uses the remaining non-data bits as reserved spare bits. The reserved spare bits can be swapped in for failing bits on the memory interface. This capability is commonly called Redundant Bit Steering (RBS) and is covered by U.S. Pat. No. 5,267,242 (assigned to International Business Machine Corp.).

Most memory interfaces use a SECDEC (Single Error Correct, Double Error Detect) ECC code, which corrects a single error and detects a double error. The unit size of the error detected or corrected is called a “symbol”, which can be one bit wide, or four bits wide as on most computer systems today. RBS is applied to replace a failing symbol with a spare symbol.

RBS avoids situations where multiple single-symbol errors align to create a multi-symbol error. In the event that an abnormal number of errors on a symbol are detected, RBS can dynamically “steer” the data stored at this symbol into one of a number of spare symbols. This both reduces exposure to multi-symbol errors as well as helping to defer maintenance until all redundant symbols have been used.

RBS techniques in many memory controllers currently allow 256 correctable errors before steering in the spare symbols. However, before the replacement, the system may have encountered other memory errors, which, when compounded with one or more of the 255 errors of failing symbols, could result in uncorrectable errors and cause serious problems including a machine check or a system crash. And, replacing the failing symbol only once with the spare symbol, even when the allowable errors are less than 256, could lead to a situation where the replaced symbol is not really defective, but has experienced a soft error, e.g., one from an alpha particle. As a result, the spare symbol cannot be used again when a hard error occurs later, which significantly limits the effectiveness of the RBS.

### SUMMARY

A method, computer program product and computer system for assigning computing resources in a computer system to solve multiple problems where tolerances to the problems are countable and have pre-set thresholds, and solutions to the problems share resources exclusively. The method, computer program product and system include counting the tolerances using at least one counter, assigning resources to solve a problem if the tolerance to the problem is higher than a first pre-set threshold, and reassigning resources to solve a second problem if the tolerance to the second problem is higher than a second pre-set threshold. The method, computer program product and system can also adopt an alternative solution that does not share resources exclusively with a current solution to solve the problems.

### BRIEF DESCRIPTION OF DRAWINGS

FIG. 1 is a block diagram showing three threshold registers and their corresponding DRAM failure ID registers in one embodiment of the present invention.

FIG. 2 is a flow chart demonstrating one embodiment of the present invention.

FIG. 3 is a conceptual diagram of a computer system that can unitize the present invention.

### DETAILED DESCRIPTION

The invention will now be described in more detail by way of example with reference to the embodiments shown in the accompanying Figures. It should be kept in mind that the following described embodiments are only presented by way of example and should not be construed as limiting the inventive concept to any particular physical configuration. Further, if used and unless otherwise stated, the terms “upper,” “lower,” “front,” “back,” “over,” “under,” and similar such terms are not to be construed as limiting the invention to a particular orientation. Instead, these terms are used only on a relative basis.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable media may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Turning to the present invention, an industry standard Dual Inline Memory Module (DIMM) composes of a series of DRAM integrated circuits. DIMMs that do not support ECC provide 64 bits (8 bytes) of data every clock cycle, whereas DIMMs that support ECC provide 72 bits (9 bytes), including 64 data bits and 8 non-data bits, per clock cycle. However, only 6 bits are needed to perform the ECC functions for the 64 bit data, thus leaving 2 bits free per DIMM as the spare bits. In the event that a chip failure on the DIMM is detected, the memory controller can re-route data around that failed chip through the spare bits.

The minimum access size on a memory interface that supports ECC is normally a full cache line of which the size varies for different processors. A single memory cache line read can be spread across more than one DIMM. For example, a 64-byte cache line read on an x86 processor can be performed across two DIMMs in 4 memory clock cycles (that is, 4 clocks*8 byte per DIMM*2 DIMMs=64 byte). Each clock cycle, 16 bytes (128 bits) data is read from the two DIMMs, along with 2 bytes (16 bits) of non-data. The DRAMs used on the DIMMs are usually “x4 configuration”, meaning 4 bits come from a single DRAM on each read clock cycle. Hence, in an RBS-enabled system that uses x86 processors with a 64-byte cache line size and reads from two DIMMs each clock cycle, the spare 4 bits can be used to replace an entire failing DRAM on the DIMM. RBS is performed on single units of one or more bits, namely symbols. On most current computer systems, a symbol is 4 bits, to match x4 DRAMs where 4 bits are provided by a DRAM on each access. RBS helps avoid a correctable Single Symbol Error from turning into an uncorrectable Double Symbol Error by removing the Single Symbol Error. “x8 configuration”, in which 8 bits are accessed by a DRAM on each access, is used more and more widely for power efficiency reasons. The present invention is applicable to “x4 configuration” and “x8 configuration”, as well as other configurations reflecting the functionality of the present invention that may be contemplated.

Many memory controllers currently set the error threshold of RBS to 256 correctable errors before steering in the spare DRAM. That is, 255 errors from a failing DRAM have occurred before the failing DRAM is replaced with the spare DRAM. During the time that DRAM first failed and the time it is replaced with the spare DRAM, the system may have encountered other memory errors, which, when compounded with one or more of the 255 errors of the failing DRAM, could result in uncorrectable errors, causing serious problems including a machine check or a system crash. A solution to this problem is to replace the failing DRAM with the spare DRAM when the first error, or a much smaller number than 256 of errors, was detected. However, the spare DRAM can be used to replace only one failing DRAM. If the DRAM experienced a soft error, e.g., one from an alpha particle, the DRAM is not really defective and should not be replaced. Otherwise, if another DRAM gets a hard failure afterwards, the spare DRAM would no longer be available to replace the hard failing DRAM.

The present invention allows the spare DRAM to be swapped in with a low number of correctable failures, but if it is detected that a second DRAM has a more catastrophic failure, the original DRAM with the low number of failures is switched back in and the redundant DRAM is then used to replace the catastrophic failing DRAM. The present invention reduces the time between when the first error occurs in a DRAM and the replacement of a DRAM with a spare DRAM for an uncorrectable error or a system crash. In the meantime, the present invention enables an adaptable RBS that can switch to cover a second DRAM if its failure is worse than the first DRAM.

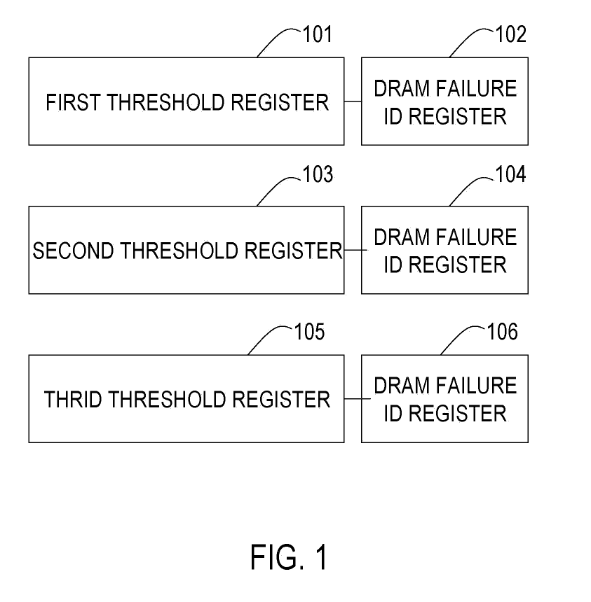

One embodiment of the present invention has three separate threshold registers along with associated DRAM failure ID registers, as illustrated in FIG. 1. There is a first threshold register 101 for the number of errors to occur on a failing DRAM, whose ID is recorded in the DRAM failure ID register 102, before activating the initial spare DRAM swap. A second threshold register 103 counts the number of additional errors on a second failing DRAM, whose ID is kept in the DRAM failure ID register 104, before switching the use of the spare DRAM to the second failing DRAM. A third threshold register 105 counts the number of additional errors detected after steering bits for the second DRAM failure before signaling system action (such as DIMM replacement). The DRAM failure ID registers 102, 104 and 106 are used to help determine the DRAM that needs be replaced. In an alternate embodiment of the present invention, the first threshold register 101 and the second threshold register 102 can be replaced by a delta counter, which counts the additional errors occurred after the previous bit steering, and triggers the corresponding actions when the count reaches its threshold.

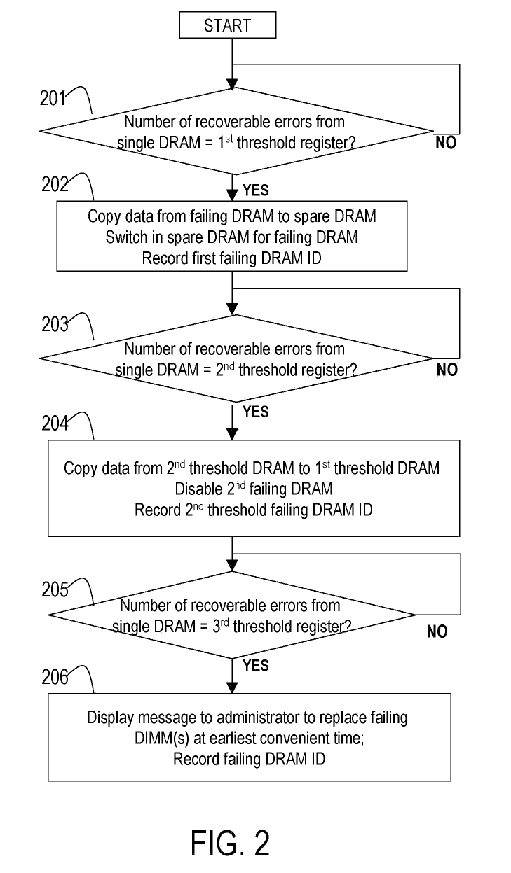

A flow chart in FIG. 2 demonstrates an embodiment of the present invention. First, in state 201, the total number of recoverable errors from each DRAM is counted and compared to the threshold set in the first threshold register 101. If there are more recoverable errors than the pre-set threshold, the failing DRAM is identified, the data from the failing DRAM is copied to the spare DRAM, the spare DRAM switched in for the failing DRAM and the ID of the failing DRAM recorded in the first DRAM failure ID register 102 (state 202). Then in state 203, the total number of recoverable errors for each DRAM is compared to the threshold set in the second threshold register 103. If more errors than allowed occur, data in the second failing DRAM will be copied to the first failing DRAM. The second failing DRAM will then be disabled and its DRAM ID will be recorded in the second DRAM failure ID register 104 (state 204). In state 205, the total number of recoverable errors for each DRAM is compared to the threshold set in the third threshold register 105. If more errors occur than the threshold, the failing ID will be recorded in the third DRAM failure ID register 106, and the administrator will be notified to replace the failing DIMM(s) (state 206).

In an example of one embodiment of the present invention, the first threshold register 101 is set to 16, the second error threshold register 103 is set to 256, and the third threshold register 105 is set to 16. In a running system, when the memory controller detects that a DRAM encounters 16 correctable errors, its ID, which is used to determine the location of the DRAM, is stored into the first ID register 102, and the spare DRAM is switched in.

If the memory controller detects that a second DRAM encounters 256 correctable errors, the original failing DRAM is switched back to free up the spare DRAM. The spare DRAM is then switched into the second failing DRAM, unless the spare DRAM was the second failing DRAM, and the DRAM ID is saved in the corresponding DRAM failure ID register 104. After switching the spare DRAM the second time, if the number of additional correctable errors reaches the threshold (16) set by in the third threshold register 105, the system signals the administrator to replace the failing DIMM(s) at the earliest convenient time. (Necessary spare DRAM switch-in/switch-back operations are involved as disclosed in U.S. Pat. No. 5,267,242.)

The present invention provides multiple error thresholds, and has the ability to reclaim the spare DRAM from a failure and reuse the spare DRAM when a subsequent failing DRAM results in a higher recoverable error count. There are multiple ways other than the presented embodiment to implement this invention, including using more than three thresholds (all increasing) or using a delta error count register that results in reusing the spare bits when the delta error count is reached.

This invention is not limited to redundant bit steering. This invention can be used for any recoverable error that uses a threshold before action is taken and has limited resources for correction, e.g., a spare lane on a bus.

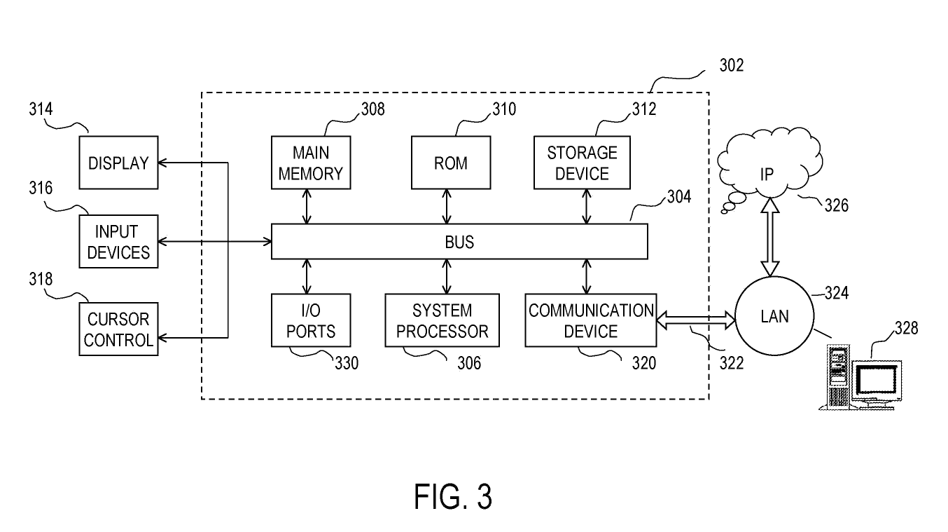

FIG. 3 illustrates a computer system (302) upon which the present invention may be implemented. The computer system may be any one of a personal computer system, a work station computer system, a lap top computer system, an embedded controller system, a microprocessor-based system, a digital signal processor-based system, a hand held device system, a personal digital assistant (PDA) system, a wireless system, a wireless networking system, etc. The computer system includes a bus (304) or other communication mechanism for communicating information and a processor (306) coupled with bus (304) for processing the information. The computer system also includes a main memory, such as a random access memory (RAM) or other dynamic storage device (e.g., dynamic RAM (DRAM), static RAM (SRAM), synchronous DRAM (SDRAM), flash RAM), coupled to bus for storing information and instructions to be executed by processor (306). In addition, main memory (308) may be used for storing temporary variables or other intermediate information during execution of instructions to be executed by processor. The computer system further includes a read only memory (ROM) 310 or other static storage device (e.g., programmable ROM (PROM), erasable PROM (EPROM), and electrically erasable PROM (EEPROM)) coupled to bus 304 for storing static information and instructions for processor. A storage device (312), such as a magnetic disk or optical disk, is provided and coupled to bus for storing information and instructions. This storage device is an example of a computer readable medium.

The computer system also includes input/output ports (330) to input signals to couple the computer system. Such coupling may include direct electrical connections, wireless connections, networked connections, etc., for implementing automatic control functions, remote control functions, etc. Suitable interface cards may be installed to provide the necessary functions and signal levels.

The computer system may also include special purpose logic devices (e.g., application specific integrated circuits (ASICs)) or configurable logic devices (e.g., generic array of logic (GAL) or re-programmable field programmable gate arrays (FPGAs)), which may be employed to replace the functions of any part or all of the method as described with reference to FIG. 1. Other removable media devices (e.g., a compact disc, a tape, and a removable magneto-optical media) or fixed, high-density media drives, may be added to the computer system using an appropriate device bus (e.g., a small computer system interface (SCSI) bus, an enhanced integrated device electronics (IDE) bus, or an ultra-direct 15 memory access (DMA) bus). The computer system may additionally include a compact disc reader, a compact disc reader-writer unit, or a compact disc jukebox, each of which may be connected to the same device bus or another device bus.

The computer system may be coupled via bus to a display (314), such as a cathode ray tube (CRT), liquid crystal display (LCD), voice synthesis hardware and/or software, etc., for displaying and/or providing information to a computer user. The display may be controlled by a display or graphics card. The computer system includes input devices, such as a keyboard (316) and a cursor control (318), for communicating information and command selections to processor (306). Such command selections can be implemented via voice recognition hardware and/or software functioning as the input devices (316).

The cursor control (318), for example, is a mouse, a trackball, cursor direction keys, touch screen display, optical character recognition hardware and/or software, etc., for communicating direction information and command selections to processor (306) and for controlling cursor movement on the display (314). In addition, a printer (not shown) may provide printed listings of the data structures, information, etc., or any other data stored and/or generated by the computer system.

The computer system performs a portion or all of the processing steps of the invention in response to processor executing one or more sequences of one or more instructions contained in a memory, such as the main memory. Such instructions may be read into the main memory from another computer readable medium, such as storage device. One or more processors in a multi-processing arrangement may also be employed to execute the sequences of instructions contained in main memory. In alternative embodiments, hard-wired circuitry may be used in place of or in combination with software instructions. Thus, embodiments are not limited to any specific combination of hardware circuitry and software.

The computer code devices of the present invention may be any interpreted or executable code mechanism, including but not limited to scripts, interpreters, dynamic link libraries, Java classes, and complete executable programs. Moreover, parts of the processing of the present invention may be distributed for better performance, reliability, and/or cost.

The computer system also includes a communication interface coupled to bus. The communication interface (320) provides a two-way data communication coupling to a network link (322) that may be connected to, for example, a local network (324). For example, the communication interface (320) may be a network interface card to attach to any packet switched local area network (LAN). As another example, the communication interface (320) may be an asymmetrical digital subscriber line (ADSL) card, an integrated services digital network (ISDN) card or a modem to provide a data communication connection to a corresponding type of telephone line. Wireless links may also be implemented via the communication interface (320). In any such implementation, the communication interface (320) sends and receives electrical, electromagnetic or optical signals that carry digital data streams representing various types of information. Network link (322) typically provides data communication through one or more networks to other data devices. For example, the network link may provide a connection to a computer (326) through local network (324) (e.g., a LAN) or through equipment operated by a service provider, which provides communication services through a communications network (328). In preferred embodiments, the local network and the communications network preferably use electrical, electromagnetic, or optical signals that carry digital data streams. The signals through the various networks and the signals on the network link and through the communication interface, which carry the digital data to and from the computer system, are exemplary forms of carrier waves transporting the information. The computer system can transmit notifications and receive data, including program code, through the network(s), the network link and the communication interface.

It should be understood, that the invention is not necessarily limited to the specific process, arrangement, materials and components shown and described above, but may be susceptible to numerous variations within the scope of the invention.

What is claimed is:

1. A method for assigning computing resources to solve a plurality of problems where tolerances to at least first and second problems are countable and have pre-set thresholds, and solutions to the plurality of problems share the computing resources exclusively, comprising:
providing a computer system loaded with the computing resources;
counting the tolerances to the at least first and second problems;
assigning the computing resources in the computer system to solve the first problem if the tolerance to the first problem is higher than a first pre-set threshold; and
reassigning the computing resources in the computer system to solve the second problem if the tolerance to the second problem is higher than one of the first pre-set threshold and a second pre-set threshold.

2. The method of claim 1, further comprising adopting an alternative solution that does not share resources exclusively with a current solution to solve the problems.

3. The method of claim 2, wherein the at least one counter comprises at least three counters, where the first counter counts the tolerance to the first problem, the second counter counts the tolerance to the second problem that has a higher tolerance threshold than the first problem, and the third counter counts a tolerance that is used to determine when to adopt the alternative solution.

4. The method of claim 2, wherein the alternative solution comprises notifying an administrator to manually solve the problems.

5. The method of claim 1, wherein the at least one counter comprises at least one delta counter, which triggers the resources reassignment when the count reaches its threshold.

6. The method of claim 1, wherein the computing resources comprise a spare DRAM, each of the problems comprises a DRAM failure, each of the tolerances comprises a number of allowed errors, and the solutions comprise replacing a failing DRAM with the spare DRAM.

7. A computer program product for assigning computing resources in a computer system to solve a plurality of problems where tolerances to at least first and second problems are countable and have pre-set thresholds, and solutions to the plurality of problems share the computing resources exclusively, the computer program product comprising:
a computer usable medium having computer usable program code embodied therewith, the computer usable program code comprising:
instructions to count the tolerances to the at least first and second problems;
instructions to assign the computing resources in the computer system to solve the first problem if the tolerance to the first problem is higher than a first pre-set threshold; and
instructions to reassign the computing resources in the computer system to solve the second problem if the tolerance to the second problem is higher than one of the first pre-set threshold and a second pre-set threshold.

8. The computer program product of claim 7, further comprising instructions to adopt an alternative solution that do not share resources exclusively with the current solution to solve the problems.

9. The computer program product of claim 8, wherein the at least one counter comprises at least three counters, where the first counter counts the tolerance to the first problem, the second counter counts the tolerance to the second problem that has a higher tolerance threshold than the first problem, and the third counter counts a tolerance that is used to determine when to adopt the alternative solution.

10. The computer program product of claim 8, wherein the alternative solution comprises notifying an administrator to manually solve the problems.

11. The computer program product of claim 7, wherein the at least one counter comprises at least one delta counter, which triggers the resources reassignment when the count reaches its threshold.

12. The computer program product of claim 7, wherein the computing resources comprise a spare DRAM, each of the problems comprises a DRAM failure, each of the tolerances comprises a number of allowed errors, and the solutions comprise replacing a failing DRAM with the spare DRAM.

13. A computer system, comprising:
a processor;
a memory operatively coupled with the processor;
a storage device operatively coupled with the processor and the memory; and
a computer program product for assigning computing resources in the computer system to solve a plurality of problems where tolerances to at least first and second problems are countable and have pre-set thresholds, and solutions to the plurality of problems share the computing resources exclusively, the computer program product comprising:
a computer usable medium having computer usable program code embodied therewith, the computer usable program code comprising:
instructions to count the tolerances to the at least first and second problems;
instructions to assign the computing resources in the computer system to solve the first problem if the tolerance to the first problem is higher than a first pre-set threshold; and
instructions to reassign the computing resources in the computer system to solve the second problem if the tolerance to the second problem is higher than one of the first pre-set threshold and a second pre-set threshold.

14. The computer system of claim 13, further comprising instructions to adopt an alternative solution that do not share resources exclusively with the current solution to solve the problems.

15. The computer system of claim 14, wherein the at least one counter comprises at least three counters, where the first counter counts the tolerance to the first problem, the second counter counts the tolerance to the second problem that has a higher tolerance threshold than the first problem, and the third counter counts a tolerance that is used to determine when to adopt the alternative solution.

16. The computer system of claim 14, wherein the alternative solution comprises notifying an administrator to manually solve the problems.

17. The computer system of claim 13, wherein the at least one counter comprises at least one delta counter, which triggers the resources reassignment when the count reaches its threshold.

18. The computer system of claim 13, wherein the computing resources comprise a spare DRAM, each of the problems comprises a DRAM failure, each of the tolerances comprises a number of allowed errors, and the solutions comprise replacing a failing DRAM with the spare DRAM.
